(19) United States
(12) Patent Application Publication
(10) Pub. No.: US 2026/0045119 A1
(43) Pub. Date: Feb. 12, 2026

(54) SPATIAL PROCESS MINING

(71) Applicant: KIT-AR LIMITED, London (GB)

(72) Inventors: Felix MANNHARDT, Eindhoven (NL); Manuel FRADINHO DUARTE DE OLIVEIRA, London (GB); João Carlos ANTUNES GONÇALVES COSTA, Odivelas (PT); Simon Justin JULIER, Kent (GB)

(73) Assignees: KIT-AR LIMITED, London, EN (GB); SKILLAUGMENT, UNIPESSOAL LDA, Ílhavo (PT)

(21) Appl. No.: 19/100,065

(22) PCT Filed: Jun. 29, 2023
(86) PCT No.: PCT/IB2023/056796

§ 371 Date: Jan. 30, 2025

(30) Foreign Application Priority Data
Jun. 29, 2022 (PT) 118073
Sep. 16, 2022 (EP) 22196244.2

(51) Int. Cl. G06V 40/20; G06F 3/01; G06V 10/762; G06V 20/20; G06V 20/70

(52) U.S. Cl. CPC G06V 40/20; G06V 10/762; G06V 20/20; G06V 20/70; G06F 3/013

(57) ABSTRACT

The present disclosure relates to a method and device for building a process map of operator physical operations in a work environment, also described as spatial process mining, in particular for an augmented reality work environment. In at least one implementation a method includes receiving acquired operation trajectories which have been previously segmented into macro-activities which include micro-activities labelled by computer-implemented detecting of previously-known micro-activity patterns; labelling the unlabelled micro-activities with a label that denotes the micro-activity was originally unlabelled; clustering, for each macro-activity, the labelled and unlabelled micro-activities based on the a respective spatial-temporal sub-trajectory of each micro-activity and the associated activity label; and outputting the clustered micro-activities for each macro-activity.

### TECHNICAL FIELD

The present disclosure relates to a method and device for building a process map comprising operator physical operations in a work environment, also described as spatial process mining, in particular for an augmented reality (AR) work environment, with corresponding AR-obtained 3D trajectories.

### BACKGROUND

Industrial augmented reality (AR) systems contextualise instruction data into specific work process instances and provide already a coarse granular subdivision in work steps. AR systems provide a frame of reference for spatial data (e.g., where was a tool used) as the work environment is mapped and put into a reference frame (e.g., through markers). AR systems record the timing and sequence of activities performed. The sequence is generally prescribed or recommended by the work instructions.

Process mining is a collection of techniques that discover, monitor, and improve work processes by using information system event logs. Event logs are used to store the timestamped sequence of events relating to (discrete) activities or tasks that occurred in a work process. Process mining has had tremendous success in providing insights into typical business processes performed via business information systems such as typical ERP systems where it is assumed that each event relates to some high-level activity. See [5] for implementation details and comprehensive information on process mining.

Wearable sensors considered in this disclosure generate a stream of data about the behaviour of the human wearer. Examples of captured data include: pose data-position and orientation—e.g. gaze and hand tracking; movement data-trajectory, velocity, acceleration—e.g. GPS, WIFI, accelerometer, inertial measurement units; contact data—other worker, tools, machine—e.g. bluetooth.

Sensors on tools and machines complement this data to provide important process context. Some examples of sensor data which are available: machine usage, machine parameters, smart tools usage (such as smart screw drivers, for example screw drives having a pick-up detector).

Event logs for process mining are easy to obtain for administrative processes with a clear digital trail, but difficult to obtain at sufficiently high-quality data for manual work activities. In manual work processes, there are many micro-steps or habits that are not captured at the typical granularity at which work steps get recorded, e.g., in a MES (Manufacturing Execution System) system only the time of completing a work step is recorded. Activity recognition techniques provide an option to recognise higher-level activities from low-level sensors data, but discrete steps (e.g., screwing, walking) are often too abstract for domain experts to make use of.

Sensor data from wearables provides an in-depth view on what happens in a manual work process. Every little movement can be recorded and traced back. However, this raw sensor data is generally too granular to be useful. Process mining cannot be directly applied if events or timestamped data do not map to recognisable activities or steps of a process. Naive visualisation of trajectories by plotting them on a 3D scatterplot, e.g., so-called Spaghetti diagrams known from their usage in Lean manufacturing projects, cannot abstract from small or irrelevant differences (e.g., a different order of certain operations) between work practices and quickly leads to unreadable visualisations.

AR systems record important contextual data on the progression of the work process. This allows the user to record and discover what happened on the shopfloor for each individual process instance and connect the fine-grained trajectory data with higher-level process information. However, a technology to fully exploit this connection is missing. Such a technology is provided by the present disclosure.

These facts are disclosed in order to illustrate the technical problem addressed by the present disclosure.

### GENERAL DESCRIPTION

The present disclosure relates to a method and device for building a process map comprising operator physical operations in a work environment, also described as spatial process mining, in particular for an augmented reality work environment.

The following provides references for the terminology in the present disclosure.

Activity refers to a discrete piece of work of the process. Activities may be on different levels or granularity. Some could be high-level activities which can be further decompose into several low-level activities.

Step is a synonym for activity and is mostly used to refer to high-level activities in this document.

(Work) process refers to a set of discrete activities that are performed together, usually in a specific sequence, with the goal to produce some result or output.

Process instance refers to a single execution of a process from start to end.

Case is a synonym for process instance.

Activity instance refers to a specific execution a specific activity, e.g., activity Step A might be repeated twice for a process case. In this case there can be two instances of Step A when performing a process. Each activity instance can be identified by a unique identifier.

Process model refers to a specification of the set of possible activities in a process and their relation to each other, i.e., execution in a sequence, branching in exclusive or parallel parts etc. Often depicted as directed graph (e.g., Petri net, Activity diagram, BPMN, https://www.bpmn.org/).

Trajectory refers to a sequence of 3D coordinates that represent the movement of some object (e.g., the hand or head of a worker) over time (e.g. a sequence of timestamped points defined by 3D coordinates, synchronized or not, between different data sources).

An aspect of the present disclosure relates to a method for building a spatial process map comprised of an operator's, i.e. a human operator, physical operations in an industrial work environment, from acquired trajectories comprising position and orientation data provided by a wearable device worn by the user over a period of time,
each trajectory corresponding to one of said operations,
each trajectory comprising a plurality of macro-activities,
each macro-activity comprising one or more labelled micro-activities, and a plurality of unlabelled micro-activities, each labelled micro-activity being an activity between unlabelled micro-activities;
each labelled micro-activity comprising a spatial-temporal sub-trajectory and an associated activity label, and each unlabelled micro-activity comprising a spatial-temporal sub-trajectory, wherein the trajectory of each labelled micro-activity is a trajectory between unlabelled micro-activity trajectories;
the method comprising the steps of:
receiving acquired operation trajectories which have been previously segmented into macro-activities comprising labelled micro-activities;
labelling the unlabelled micro-activities with a label that denotes the micro-activity was originally unlabelled;
clustering, for each macro-activity, the labelled and unlabelled micro-activities based on the respective spatial-temporal sub-trajectory and the associated activity label;
outputting the clustered micro-activities for each macro-activity.

It is thus also that an aspect of the present disclosure relates to a method for building a spatial process map comprised of an operator's, i.e. a human operator, physical operations in an industrial work environment, from acquired trajectories comprising position and orientation data provided by a wearable device worn by the user over a period of time,
each trajectory corresponding to one of said operations,
each trajectory comprising a plurality of macro-activities,
each macro-activity comprising one or more labelled micro-activities, and a plurality of unlabelled micro-activities, each labelled micro-activity being an activity temporally between unlabelled micro-activities; each macro-activity thus comprising micro-activities which are temporally sequenced and nonoverlapping [i.e. total ordered],
each labelled micro-activity comprising a spatial-temporal sub-trajectory of the macro-activity trajectory and an associated activity label, and each unlabelled micro-activity comprising a spatial-temporal sub-trajectory of the macro-activity trajectory, wherein the trajectory of each labelled micro-activity is a trajectory temporally and spatially between unlabelled micro-activity trajectories;
the method comprising the steps of:
receiving acquired operation trajectories which have been previously segmented into macro-activities comprising labelled micro-activities;
labelling the unlabelled micro-activities with a label that denotes the micro-activity was originally unlabelled;
clustering, for each macro-activity, the labelled and unlabelled micro-activities based on a respective spatial-temporal sub-trajectory of each micro-activity and the associated activity label;
outputting the clustered micro-activities for each macro-activity.

Unlabelled activities are thus those that constitute the time between activities for which there are labels; this means assigning a “unlabelled” label, whether an implicit label or an explicit label, to the unlabelled micro-activities in order for these to be usable in learning.

Micro-activities are labelled by computer-implemented detecting of previously-known micro-activity patterns in each previously segmented macro-activity and by labelling each detected micro-activity of each segmented macro-activity.

Note that in practical circumstances, there usually is an unlabelled, even if relatively short, time frame at beginning and end of each capture, thus each labelled micro-activity being an activity temporally between unlabelled micro-activities.

Implicit labelling is also included here, whereby the lack of a label is also used by the clustering step as useful information, thus being equivalent to labelling the unlabelled micro-activities with a label that denotes the micro-activity was originally unlabelled.

Received operation trajectory and received macro-activity data necessarily entails that the industrial work environment is not random; there is structure in such environment. Furthermore, labelled micro-activities are automatically detected which entails that there are some micro-activities that are recurring enough to be recognized (and labelled).

A sub-trajectory of a micro-activity is a spatial-temporal segment of the operation trajectory corresponding to said micro-activity.

In an embodiment, the method comprises acquiring said acquired operation trajectories comprising position and orientation data by acquiring 3D position and 3D orientation data provided by an augmented-reality or virtual-reality wearable device as it is being worn by the operator.

Augmented-reality or virtual-reality wearable device is to be understood as including XR extended-reality wearable devices.

In an embodiment, the wearable device is an augmented reality device.

In an embodiment, the acquiring of 3D position and 3D orientation data is provided by further wearable device or devices.

In an embodiment, the trajectories are head trajectories of the operator and the wearable device is a head-wearable device, in particular the head-wearable comprising a 3D tracking camera or an inertial sensor.

An inertial sensor is usually termed as an IMU, inertial measurement unit, comprising gyroscopes, accelerometers, and/or magnetometers.

In an embodiment, the trajectories are head and hand trajectories of the operator and the wearable device is a head-wearable device comprising a 3D tracking camera.

In an embodiment, the trajectories are hand trajectories of the operator and the wearable device is a hand- or wrist-wearable device comprising a location and orientation sensor.

In an embodiment, the trajectories are head and gaze trajectories of the operator and the wearable device is a head-wearable device comprising a 3D tracking camera comprising eye-tracking capabilities.

In an embodiment, the method of the present disclosure further comprises the subsequent steps of:
for each micro-activity within each clustered macro-activity, identifying a most representative micro-activity trajectory;
concatenating the identified most representative micro-activity trajectories of each clustered macro-activity;
outputting the concatenated micro-activity trajectories for each macro-activity.

In an embodiment, the method of the present disclosure further comprises the subsequent steps of:
for each clustered macro-activity, identifying a most representative macro-activity trajectory;
outputting the concatenated micro-activity trajectories for each macro-activity.

In an embodiment, the most representative trajectory is selected using a median trajectory selection.

A media trajectory can be calculated according to Buchin et al, Median Trajectories. Algorithmica 66, 595-614 (2013), https://doi.org/10.1007/s00453-012-9654-2.

A median trajectory is central with respect to the number of given trajectories.
As an example for a median trajectory selection, let a set T={τ1, . . . , τm} of m trajectories be given, each containing n vertices. Assume for convenience that all trajectories start at the same point s and end at the same point t. Assume that no trajectory passes through s or t a second time and that s and t are incident to the unbounded face of the arrangement of curves corresponding to the trajectories. Also assume a direction on the trajectories, namely from s to t, and for convenience assume that m is odd. Finally, assume that the curves do not touch or coincide with each other or themselves at any point, unless they cross, and no three trajectories pass through a common point. Several required properties of the median trajectory:
   1. The median trajectory is a polygonal curve from s to t.
   2. Any point on the median trajectory lies on some trajectory of the input.
   3. Any edge of the median trajectory has the same direction as the edge of the input trajectory on which it lies.
   4. For any point p on the median trajectory, the minimum number of distinct trajectories that p must cross to reach the unbounded face (including the one(s) on which p lies) is (m+1)/2.
According to Buchin et al, a simple definition of median trajectory is: It is the trajectory obtained after leaving s in the only possible way while satisfying the last property, and then switching the trajectory at every intersection point, following the next trajectory in the forward direction.

In an embodiment, the method of the present disclosure comprises the preparation step of acquiring position and orientation data provided by a wearable device worn by the user over a period of time when the physical operations are being carried out.

In an embodiment, the method of the present disclosure, in said preparation step acquiring gaze data for a plurality discrete-time events provided by an eye-tracking device, said gaze data comprising for each event a timestamp, and also comprising a gaze orientation, an identification of a work environment being gazed upon, gaze duration, or combinations thereof.

In an embodiment, the method of the present disclosure comprises smoothing the acquired position and orientation data over time, in particular smoothing gaze orientation.

In an embodiment, the method of the present disclosure comprises the preparation step of segmenting the acquired position and orientation data into a plurality of trajectories, each trajectory corresponding to one of said operations.

In an embodiment, the method of the present disclosure comprises the preparation step of receiving each trajectory corresponding to one said operation, each trajectory comprising a plurality of macro-activities, from an industrial workflow system.

In an embodiment, the method of the present disclosure comprises in said segmenting step, segmenting the acquired position and orientation data, using the acquired gaze data, into a plurality of trajectories, each trajectory corresponding to one of said operations.

In an embodiment, the method of the present disclosure comprises a preparation step of segmenting each trajectory into a plurality of macro-activities, each macro-activity being defined by an industrial workflow system.

In an embodiment, the method of the present disclosure comprises a preparation step of detecting previously-known micro-activity patterns in each segmented macro-activity and labelling each detected micro-activity pattern of each segmented macro-activity.

In an embodiment, the method of the present disclosure comprises detecting previously-known micro-activity patterns in each segmented macro-activity and labelling each detected micro-activity pattern of each segmented macro-activity, using the acquired gaze data.

In an embodiment, the method of the present disclosure comprises, for each macro-activity, obtaining a sequence graph of the corresponding micro-activities, using the outputted clustered micro-activities for each macro-activity.

In an embodiment, for each macro-activity, obtaining a dispersion measure of the corresponding micro-activities, using the outputted clustered micro-activities for each macro-activity.

In an embodiment, the method of the present disclosure comprises calculating a conformance measure using the outputted clustered micro-activities for each macro-activity.

In an embodiment, the method of the present disclosure comprises replaying in augmented or virtual reality the outputted clustered micro-activities for a user-selected macro-activity.

Another aspect of the present disclosure relates to a device for building a spatial process map comprised of an operator's physical operations in an industrial work environment, from acquired trajectories comprising position and orientation data provided by a wearable device worn by the user over a period of time;
each trajectory corresponding to one of said operations;
each trajectory comprising a plurality of macro-activities;
each macro-activity comprising micro-activities which are temporally sequenced and nonoverlapping,
said micro-activities comprising one or more labelled micro-activities, and a plurality of unlabelled micro-activities,
each labelled micro-activity being an activity temporally between unlabelled micro-activities;
each labelled micro-activity comprising a spatial-temporal sub-trajectory and an associated activity label, and each unlabelled micro-activity comprising a spatial-temporal sub-trajectory, wherein the trajectory of each labelled micro-activity is a trajectory spatially between unlabelled micro-activity trajectories;
   the device comprising an electronic data processor configured for carrying out the steps of:
receiving acquired operation trajectories which have been previously segmented into macro-activities comprising labelled micro-activities, micro-activities being previously labelled by computer-implemented detecting of previously-known micro-activity patterns in each previously segmented macro-activity and labelling each detected micro-activity of each segmented macro-activity;
labelling the unlabelled micro-activities with a label that denotes the micro-activity was originally unlabelled;
clustering, for each macro-activity, the labelled and unlabelled micro-activities based on a respective spatial-temporal sub-trajectory of each micro-activity and the associated activity label;
outputting the clustered micro-activities for each macro-activity.

### REFERENCES

1. H. Jeung, Q. Liu, H. T. Shen, and X. Zhou, “A Hybrid Prediction Model for Moving Objects,” in 2008 IEEE 24th International Conference on Data Engineering, April 2008, pp. 70-79, doi: 10.1109/ICDE.2008.4497415.
2. Y. Zheng and X. Zhou, Eds., Computing with Spatial Trajectories. New York: Springer-Verlag, 2011.
3. Y. Zheng, “Trajectory Data Mining: An Overview,” ACM Trans. Intell. Syst. Technol., vol. 6, no. 3, p. 29:1-29:41, May 2015, doi: 10.1145/2743025.
4. G. Yuan, P. Sun, J. Zhao, D. Li, and C. Wang, “A review of moving object trajectory clustering algorithms,” Artif. Intell. Rev., vol. 47, no. 1, pp. 123-144, January 2017, doi: 10.1007/s10462-016-9477-7.
5. Van der Aalst, W. M, “Process mining: data science in action. Springer.”, 2016, doi: 10.1007/978-3-662-49851-4.
6. [Buchin, K., Buchin, M., van Kreveld, M. et al. Median Trajectories. Algorithmica 66, 595-614 (2013). https://doi.org/10.1007/s00453-012-9654-2]

The above references are herewith incorporated by reference.

### BRIEF DESCRIPTION OF THE DRAWINGS

The following figures provide preferred embodiments for illustrating the disclosure and should not be seen as limiting the scope of invention.

FIG. 1 illustrates an illustrative embodiment of the process of spatial replay.

FIG. 2 illustrates an illustrative embodiment of the process of spatial discovery.

FIG. 3 illustrates an illustrative embodiment of the process of spatial conformance.

FIG. 4 shows an illustrative embodiment of the timestamp alignment on a common relative timescale. Note that each trajectory is simplified for illustration purposes as a single time series.

FIG. 5 shows an illustrative embodiment of the correlation between activity instances of the process and the trajectories recorded between start and completion of the individual activity instances.

FIG. 6 shows an illustrative embodiment of the process of normalisation of trajectory data collected in different coordinate systems.

FIG. 7 is an illustrative embodiment of an overview of the steps for generating a spatial replay animation according to the disclosed method.

FIG. 8 is an illustrative embodiment of a replay animation rendering.

FIG. 9 shows an illustrative embodiment of the steps of the disclosed spatial discovery method.

FIG. 10 shows an illustrative embodiment of the activity recognition types.

FIG. 11 shows an illustrative embodiment of the result of the activity recognition step for a single activity instance of a single process instance. A partially ordered sequence of low-level activities is added to the data that is shown in the upper part of this illustration.

FIG. 12 shows an illustrative embodiment of the input data for the trajectory clustering step, a set of many spatio-temporal and process-annotated 3D trajectories.

FIG. 13 shows an illustrative embodiment of the input data to the spatio-temporal and process-aware clustering method.

FIG. 14 shows an illustrative embodiment of the result of the spatial and process behaviour clustering. Several clusters will be discovered each representing a distinct work practice.

FIG. 15 shows an example process model identified on the low-level behaviour observed for a cluster (based on Case 1 in FIG. 10) while performing a single activity of the process.

FIG. 16 shows an illustrative embodiment of where the spatial process model provides the connection between the process behaviour (sequences of low-level activities) and the spatial behaviour (movement/trajectory of the worker).

Two examples are shown for Cluster A and Cluster B in which Case 1 and Case 4 were chosen as representatives of their cluster. Elements of the process model can be clicked on the corresponding segment of the trajectory is shown and replayed. For example, in Cluster A the spatial behaviour representative for Cluster A when doing the Place activity is shown.

FIG. 17 shows an illustrative embodiment of the steps of the disclosed spatial discovery method.

### DETAILED DESCRIPTION

The present disclosure relates to spatial process mining.

An aspect of the present disclosure aims to provide new insights on manual labour in processes from data recorded by systems and body-worn sensors (wearables) by integrating process execution (process events) and spatial information (spatial movement of workers) of the process.

In an embodiment, high-level data from event logs (e.g., MES records, work logs, stepwise instructions) that shows what high-level activities are (or should be) done according to the process execution perspective is integrated with sensor data reflecting the movement and actions of participating human workers showing how those high-level activities are executed according to the spatial perspective.

An aspect of the present disclosure is to strike a balance between providing high-level information on the sequence of steps that were executed and showing the details of how the work was performed. Spatial Process Mining refines and integrate event logs with sensor logs to identify training needs, process improvement opportunities, compliance violations, and provides full traceability of operations.

Spatial Process Mining consists of the following three different basic techniques.

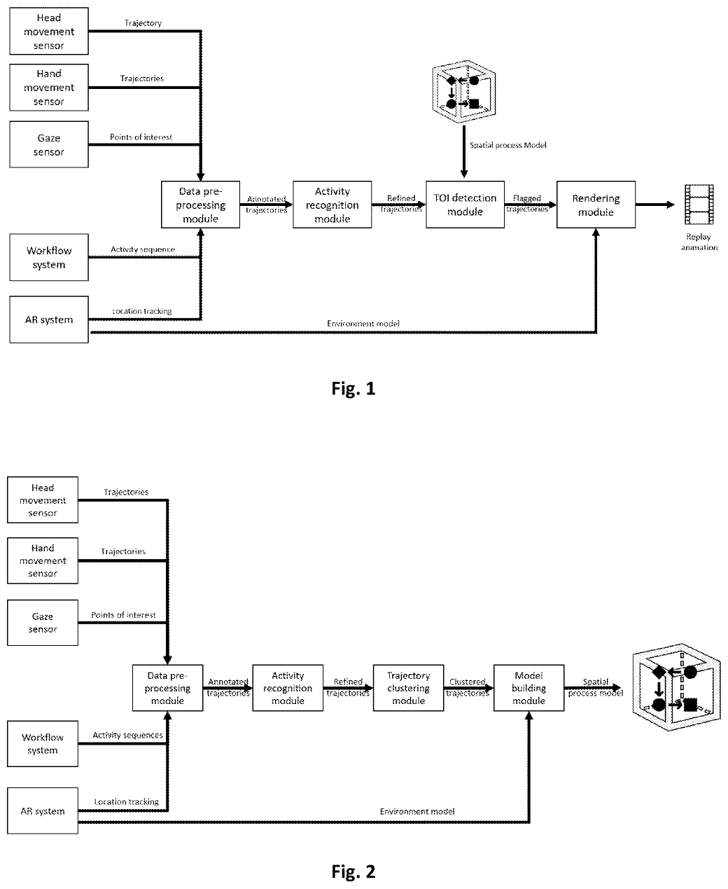

In an embodiment, spatial replay is performed. Here the input is a single process instance of an assembly process for which worker movement data is recorded. This data is correlated with the process events coming from a workflow system, and the system attempts to filter out some irrelevant movement data, detects time frames of interest to be flagged, and uses this to create a computer-generated animation of the single process instance. (FIG. 1)

In an embodiment, spatial discovery is performed. Here the goal is to obtain a compact process model which represents both the process and the spatial behaviour. It is derived from observing the movement of workers over multiple instances of the same process. The activity instances of the observed process instances are grouped according to different work practice clusters and, then, a set of representative movement patterns for each activity is output using a computer-generated visualisation aligned with a process model that is automatically discovered based on recognised low-level activities. (FIG. 2)

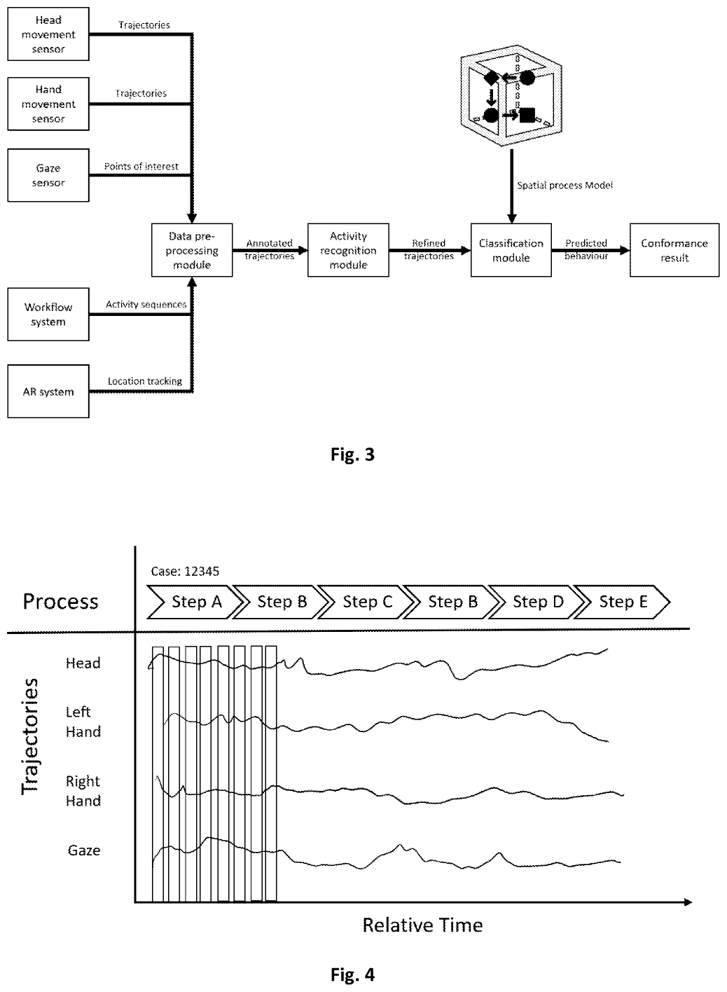

In an embodiment, spatial conformance is performed. Here the goal is to classify a currently (i.e., online classification) performed work process instance, or previously acquired work process instance data, as deviating or non-deviating regarding the Spatial Process Model that was previously discovered. This classification provides insights on whether the work is likely to encounter conformance issues and provide optimal assistance. (FIG. 3)

In an embodiment, the following sensor and event data sources outlined in Table 1 are required for the spatial process mining of the present disclosure.

TABLE 1
Input data

| Name | Type | Source | Definition |
|---|---|---|---|
| Workers | Master | Workflow | A fixed set of workers W = {W₁, . . . , W_{N}} that |
| | | system | are involved in the process instance. |
| | | | Optionally, information such as body height |
| | | | of the worker. |
| Activities | Master | Workflow | A fixed set of activities A = {A₁, . . . , A_{N}} that |
| | | system | are carried out in the process instance. For |
| | | | each activity, spatial information on where |
| | | | the activity is taking place in coordinates |
| | | | relative to a workshop location. |
| Objects | Master | Workflow | A fixed set of objects O = {O₁, . . . , O_{N}} that |
| | | system | are manipulated or used in the process |
| | | | instance. For each object, an initial spatial |
| | | | location may be additionally specified. |
| Workspaces | Master | AR system | A fixed set of workspace locations L = |
| | | | {L₁, . . . , L_{N}} in which the process is |
| | | | performed. Each location may be associated |
| | | | with one or more markers that can be used |
| | | | to localise the coordinates of the |
| | | | workspace. |
| Activity | Event | Workflow | Sequence of discrete events < |
| (instance) | | system | e₁, e₂, . . . , eₙ > each labelled with: |
| sequence | | | a worker w ∈ W, |
| | | | an activity a ∈ A, |
| | | | a set of objects Oₐ ⊆ O, |
| | | | the location in which the activity |
| | | | was performed l ∈ L, |
| | | | a start timestamp tₛ ∈ [symbol] and |
| | | | a completion timestamp t_{c} ∈ [symbol] |
| | | | both on some relative scale. |
| Head | Spatial | Wearable | For each worker w ∈ W: |
| trajectory | | Headset | A sequence of 3D coordinates and |
| | | camera | orientations tr_{head} = < |
| | | | (c₁, t₁), . . . , (cₙ, tₙ) > with cᵢ = |
| | | | (xᵢ, yᵢ, zᵢ, qxᵢ, qyᵢ, qzᵢ, qwᵢ), or equivalent |
| | | | notations, wherein the trajectory |
| | | | coordinates at timestamp tᵢ ∈ [symbol] where |
| | | | xᵢ, yᵢ, zᵢ ∈ [symbol] are cartesian coordinates and |
| | | | qxᵢ, qyᵢ, qzᵢ, qwᵢ ∈ [symbol] are quaternions of |
| | | | the head orientation. |
| Hand | Spatial | Hand | For each worker w ∈ W: |
| trajectory | | tracking | For each hand and each joint: A sequence of |
| | | sensor | 3D coordinates and orientations: trⱼₒᵢₙₜ = < |
| | | | (c₁, t₁), . . . , (cₙ, tₙ) > with cᵢ = |
| | | | (xᵢ, yᵢ, zᵢ, qxᵢ, qyᵢ, qzᵢ, qwᵢ) the trajectory |
| | | | coordinates at timestamp tᵢ ∈ [symbol] where |
| | | | xᵢ, yᵢ, zᵢ ∈ [symbol] are cartesian coordinates and |
| | | | qxᵢ, qyᵢ, qzᵢ, qwᵢ ∈ [symbol] are quaternions of |
| | | | the joint orientation. |
| Gaze | Spatial | Eye | For each worker w ∈ W: |
| trajectory | | tracking, | A sequence of 3D coordinates and, possibly, |
| | | Raytracing | object identifiers of objects of interest: |
| | | | tr_{gaze} = < |
| | | | ((x₁, y₁, z₁), o₁, t₁), . . . , (xₙ, yₙ, zₙ), oₙ, tₙ) > |
| | | | with xᵢ, yᵢ, zᵢ ∈ [symbol] the coordinates of where |
| | | | the gaze intersected with object of interest |
| | | | oᵢ ∈ O at timestamp tᵢ ∈ [symbol] . |
| Location | Spatial | AR system | Position and orientation |
| tracking | | (Marker | (t, xᵢ, yᵢ, zᵢ, qxᵢ, qyᵢ, qzᵢ, qwᵢ) in sensor |
| | | tracking, | coordinate frame of a reference point or |
| | | Object | object that is related to a specific location |
| | | detection) | l ∈ L for a specific sensor. In case multiple |
| | | | sensors are used to track the spatial data, |
| | | | the location tracking needs to be performed |
| | | | for each sensor. |

In an embodiment, data pre-processing was performed. The input data listed in Table 1 may originate from different sensors and systems. Those sensors and systems are not necessarily connected to each other and, therefore, do not necessarily use the same timescales and coordinate frames. Therefore, there is a need to correlate and transform the data such that it follows a common timeline, process context, and a common spatial context. The individual data correlation steps explained in the following text are used to obtain what we denote as Annotated Trajectories.

In an embodiment, the timestamps were aligned. All trajectory data recorded for a process instance were aligned on a relative timescale. As illustrated in FIG. 4, the start of the process instance, i.e., the start the initial activity Step A1 of the process, is set at time 0 and the recorded trajectory data is aligned along a common sampling rate that provides a regular sequence of timesteps with a chosen resolution. The resolution is case dependent, e.g., it could be that measurements are averaged over a window of 50 milliseconds yielding a measurement at relative time Oms, 50 ms, 100 ms, and so on.

In case sensor data is missing or recorded with a varying granularity, suitable methods for interpolating missing sensor values are to be used. Besides simple linear interpolation, more advanced prediction models, e.g., Kalman or Particle filters or exploiting the information in the past trajectory before as described in [1] could be used. (FIG. 4)

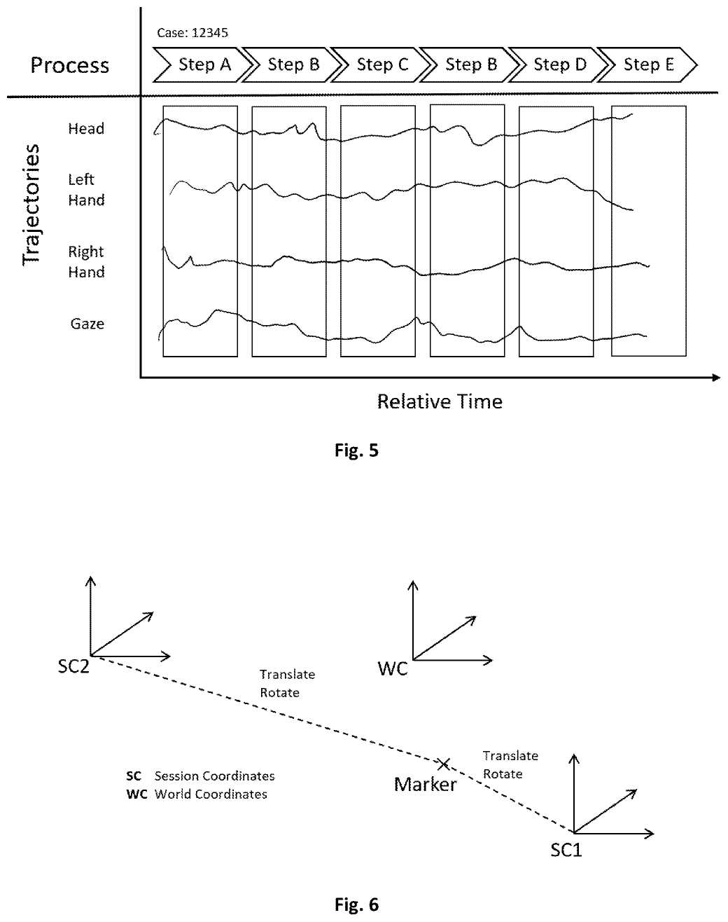

In an embodiment, activity instances were correlated. Each timestep that was created in the step above was correlated with a specific activity instance based on the recorded start and completion timestamp. In case there is not activity instance activities (e.g., a break between two subsequent activities) we assign a generic placeholder activity for breaks between regular activities. (FIG. 5)

In an embodiment, the spatial information was normalised. The various types of spatial data are likely to use different coordinate frames among each other (e.g., when the sensor resides on different physical hardware), for each subsequent process instance (e.g., when the sensor was initialised or rebooted), or for each subsequent activity instance (e.g., when the process spans multiple locations). Thus, there is a need to normalise the data such that a common coordinate system origin is used for each physical location. A marker-based tracking, which uses recognizable features in the environment, whether already present or intentionally placed as a marker, in fixed or mobile placements, is used to achieve normalisation of the data. The coordinate and orientation of one or more specific marker objects that are attached to known and fixed position with regard to the workspace location were recorded. Markers are likely already used to display AR instructions. The coordinates of the markers were used to translate and rotate the sensor coordinates that are relative to the respective session coordinate system (SC1 and SC2 in the FIG. 6) such that the coordinate origin in world coordinates (WC) can be placed at a fixed position relative to the marker locations. The marker positions are continuously tracked since their location may change in a scenario in which objects are moving, e.g. on an assembly line.

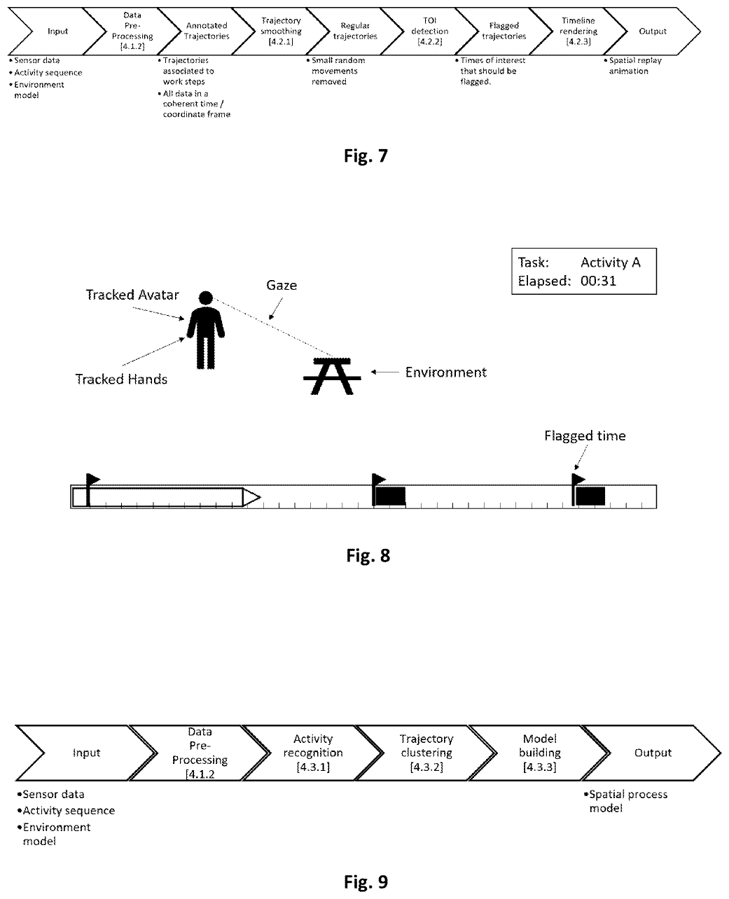

In an embodiment, spatial replay was performed. Spatial Replay uses historic data on the worker movement and the sequence of work process activities of a single work process instance (case) to generate a normalised 3D animation of the work performed. The goal is to provide traceability and insights into a single process instance such that the work can be reviewed in a fixed timeframe. The animation is generated based on two main factors: process sequence and worker movement and placed inside a 3D model of the environment in which the work process took place (e.g., spatial mesh). The input to Spatial Replay is the trajectory and event data recorded for a single process instance as well as aggregated data (trajectories and events) on past executions of the same process. The output is an interactive spatial replay animation that is closely linked to the process sequence. (FIG. 7) Spatial Replay refines the raw data in several steps.

In an embodiment, trajectory smoothing was performed. Having obtained a set of Annotated Trajectories, the spatial sensor data is still likely to be noisy in nature. The term ‘noise’ refers to high variability in the data that is not solely due to measurement error but also includes factors affecting the recordings that are irrelevant to the analysis objective. For example, small movements of the worker that have nothing to do with the work. Fine-granular movements are recorded that, depending on the application area, are irrelevant to the assembly process at hand. Some of these small movements may not be relevant to the work performed and distracting an analyst from observing the main behaviour. However, also measurement error is likely to occur and if infrequent can be removed by smoothing.

Several smoothing methods are available that can be applied, some of which are well described in [2], [3]. They fall roughly into the following categories: Mean/Median Filters, Kalman or Particle Filters, Outlier Detection Methods. The results of this noise filtering step are called Regular Trajectories.

In an embodiment, Times of Interest (TOI) detection was performed. Based on the regular trajectories, this step in our Spatial Replay method aims to identify times of interest (TOIs) during the process execution. The aim is to provide an indication to a process analyst which parts of the process execution warrant closer inspection. This is to avoid having to review a large amount of replay animations.

Several methods may be used to identify TOIs, for example:
Deviation from the regular movement based on a set of reference process instances and basic statistical comparison (e.g., strong deviation from a median trajectory).
Deviation from the regular sequence of low-level activities that are underlying the process instance. Low-level activities may be detected through activity recognition modules.
Deviation from the regular time required for activities (too fast/too slow)
   After identification of TOIs the respective timeframes (start and completion) are attached as metadata to the Regular Trajectory.

In an embodiment, timeline rendering was performed. A replay animation in 3D is rendered for each individual process instance based on the set of flagged trajectories. The worker movement is rendered based on a virtual avatar of the worker that moves through a scene based on the provided environment model (e.g., by capturing the spatial mesh of the environment using an AR device). The worker avatar is positioned according to the spatial sensor data on posture and position. Next to the worker avatar, information on the currently performed activity and the processing time is displayed in form of an overlay. (FIG. 8)

A ghost avatar showing the most common movement performed in previous process instance for the same process can be shown. The speed at which the animation ‘replays’ the process execution is configurable and should provide a balance between providing the replay in a short timeframe and allowing to identify the movements carried out in individual activities. The camera angle is automatically changed to provide a view on the operations carried out by the worker. (FIG. 8)

In an embodiment, spatial discovery was performed. The Spatial Discovery technique provides identification of notable clusters of spatial behaviour (movement, focus) in a repetitive work process and based on these clusters derive prototypical work process behaviour. The spatial behaviour is observed as a series of spatio-temporal trajectories each of which is related to an activity instance of the work process. Spatial Discovery goes beyond a simple replay animation by taking a large set of process instances, for which it is assumed that the work should be done in a similar manner and infers an overall behavioural model taking into account both the process sequence and the worker movement observations.

The input to Spatial Discovery is a set of annotated trajectories as well as a model (3D and semantic) of the environment in which the work process took place. This is like Spatial Replay; however, for this technique a large set of process instances for the same work process is considered together.

The output of the method is a behavioural spatial process model consisting of a behavioural model on the level of low-level activities together connected with clusters of trajectory information, i.e., it allows to identify different work practices for individual activities.

FIG. 9 shows the main steps of the Spatial Discovery methods, which are described in more detail in the following text.

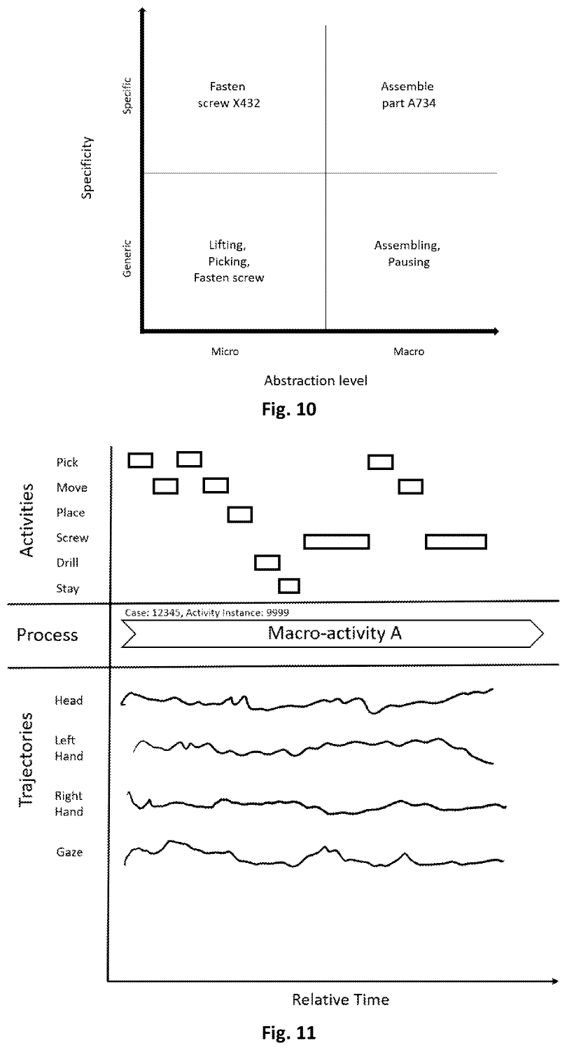

In an embodiment, activity recognition was performed. The set of annotated trajectories are first used as input to one or more activity recognition modules. Activity recognition may occur at different abstraction levels and target different kinds of activities. (FIG. 10) Broadly speaking, activities recognition modules were distinguished based on their abstraction level and the kind of activities detected as shown in FIG. 10:
Micro-level activities, which describe what happens from a low-level perspective and are likely to be performed as part of several higher-level activities.
Macro-level activities, which describe what happens from a high-level perspective and are likely to be composed of several micro-level activities.
Generic activities, which are likely to be useful in any application scenario.
Specific activities, which are only relevant in a particular application scenario.

An activity recognition module may also return that it was unable to reliably classify the activity currently performed.

The Spatial Discovery technique aims to identify micro-level activities that are not yet encoded in the workflow events received from the workflow or AR instruction system. In general, generic activities will be detected. Each activity recognition module uses the input data, possibly accumulated over a certain time window, to classify the most likely activity currently performed according to its set of known activities. Modules use a variety of technique (e.g., Hidden Markov Models, Deep Learning, etc.) based on the use case. An activity recognition module may also return that it was unable to reliably classify the activity currently performed, in which case we add a placeholder activity representing this fact to the dataset. (FIG. 11)

The result of this step is a set of Refined Trajectories in which the activity sequence is extended with additional lower-level events, which may be concurrent to the original sequence of high-level activities provided by the AR instruction system (i.e. workflow system) as shown in FIGS. 1-3. Any of these recognised activities are likely to have a defined duration by estimating a start and completion timestamp, alongside with the recognised activity.

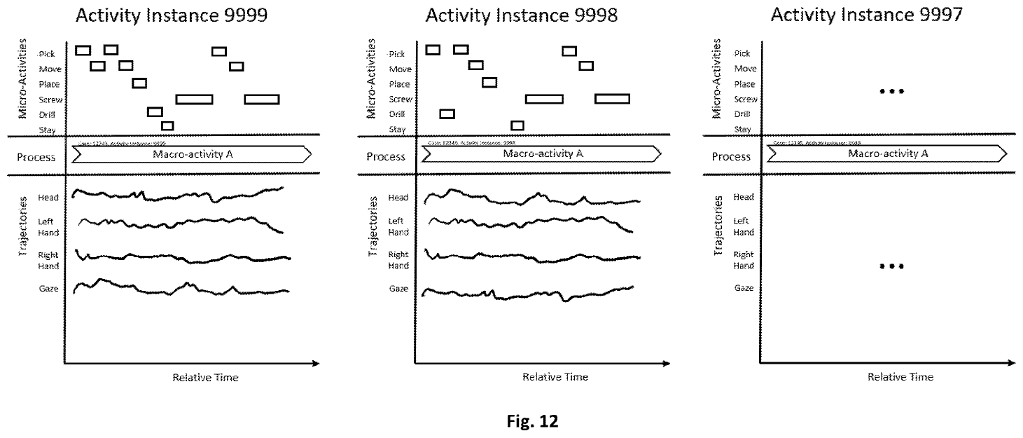

In an embodiment, trajectory clustering was performed. For each high-level activity, i.e., the activity that is given by the AR instruction system, of a process we have now a set of Refined Trajectories recorded. Each Refined Trajectory is linked to a single activity instance and follows the structure shown in FIG. 8. However, the granularity of this information is too fine to be useful for a production engineer who wants to be able to quickly see what kind of different work practices are present. Instead of reviewing every single process instance and every single activity instance, the aim is to group together activity instance that are performed in a similar manner. (FIG. 12)

Therefore, clustering was employed to group together those activity instances (across different process instance of the same process) that exhibit similar spatial and process behaviour. The disclosure combines the spatial behaviour with the information obtained on the process behaviour. In the context of a single (high-level) activity instance the process behaviour is determined by the partially ordered sequence of recognised low-level activities disclosed in the present disclosure.

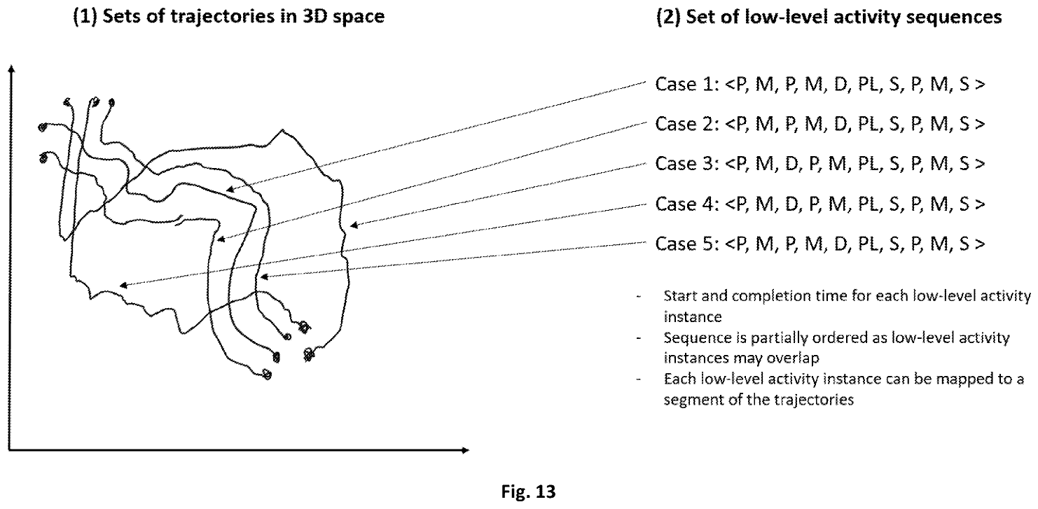

Many approaches have been proposed for spatio-temporal clustering of trajectories all relying on suitable distance measures between any two trajectories considered [4]. Common distance or similarity measures are closest-pair distance and sum-of-pairs distance for trajectories with common length, which would be very likely not applicable in our case. More advanced distance measure uses dynamic time warping to allow repetition of certain points of the trajectory to better align any two trajectories of different length or longest common subsequence or edit distance, which is inspired by the similar names distance measures use to match strings (FIG. 13). In the present disclosure, distance measures are thus used, for example, as described in [4].

In an embodiment, unlike the current state-of-the-art in trajectory clustering, the additional information conveyed by the process behaviour was used. As illustrated in FIG. 13, in addition to the set of trajectories in 3D space (head trajectory, hand trajectories, gaze trajectory), the sequence of recognised low-level activity instances was also used as input. Combining these two datasets results in a set of segmented trajectories. In a segmented trajectory each coordinate is annotated with a set of currently active low-level activities if any. This means that each trajectory can be subdivided into one or more segments based on which low-level activity was performed. The input to the clustering is therefore a sequence ST of segmented trajectories:

$$ST = < ( {t}_{1} , ( {tr}_{1 , 1} , {tr}_{1 , 2} , … , {tr}_{1 , n} ) , ( {a}_{1 , 1} , {a}_{1 , 2} , … , {a}_{1 , m} ) ) , … , ( {t}_{k} , ( {tr}_{k , 1} , {tr}_{k , 2} , … , {tr}_{k , n} ) , ( {a}_{k , 1} , {a}_{k , 2} , … , {a}_{k , m} ) ) >$$

Assuming k samples were taken at timestamps t₁, t₂, . . . and that for each sample n different trajectories are recorded, and k different low-level activities may be potentially active. Each trajectory tr_{i,j} has the information on 3D coordinates and orientation of the trajectory j as defined in the present disclosure and each activity indicator a_{i,j} is the result of the indicator function whether the low-level activity aⱼ∈A was active at the timestamp tᵢ.

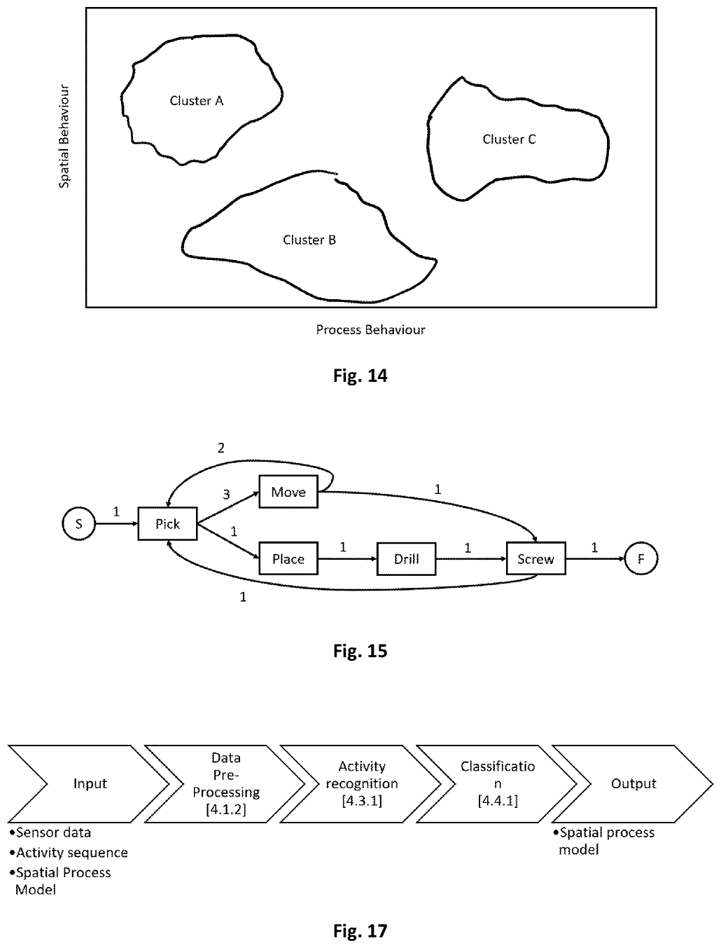

Thus, state-of-the-art trajectory clustering approaches, which operate with a similarity measure on the trajectories part (tr_{1,1}, tr_{1,2}, . . . , tr_{1,n}) of the vector ST, can be combined with a similarity measure for currently performed activities as one-hot encoded or bag-of-word in case of multiple activities being active at the same time encoded vector. This allows, for example, to treat the trajectories recorded when no activity was performed differently from the trajectories when the same activity was performed. (FIG. 14)

As a result of this step, a set of clusters was obtained for each activity as illustrated in FIG. 13. Each cluster contains a set of activity instance, i.e., recordings of how workers performed the work in a single instance of the activity. The assumption is that each cluster represents a distinct work practice. There may also be outliers that cannot be associated with a cluster. These cases of outliers may be relevant from a process compliance perspective.

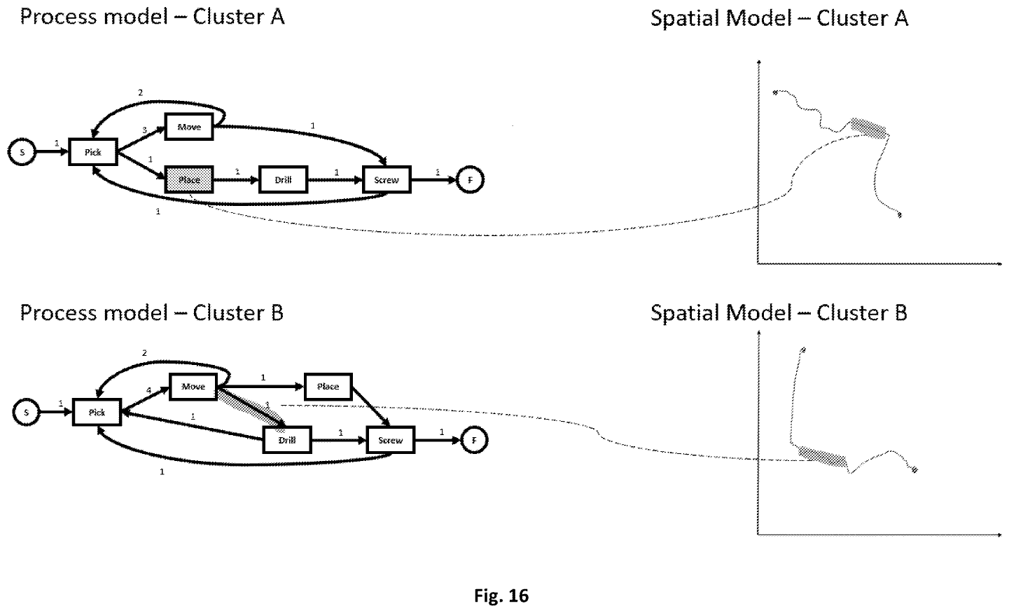

In an embodiment, model discovery was performed. The grouped and aligned trajectories for each individual activity instance provide us prototypes of the different work practices as observed by following the workers movements. The purpose is to build a behavioural process model for each of these clusters by discovering process models, i.e., visual representations of the follows relations and dependencies between low-level activities. Each activity is visualised as a node of the graph and precedence relations between activities are visualised as directed edges of the graph. In addition to this structural information, the discovered process model, e.g., as shown in FIG. 15, shows the frequencies and dependencies as observed in the cluster as annotations. The activities and edges in each process model are now associated with a set of trajectories that were observed when performing the respective low-level activities or in the idle time between two of the low-level activities. Thus, there is a bidirectional relationship between boxes and edges on the one hand and segments of the cluster representative trajectory and the other hand. In short, the present disclosure uses as data points both the identified activities and the time periods between the identified activities. All these data points are thus preferably used for linking with trajectory data. We exploit this relationship, to provide an interactive visualisation as sketched in FIG. 16. On the left side of the screen, the respective process model discovered from the low-level activities for each cluster is shown. On the right side of the screen, the representative trajectories connected to each of the clusters are visualised in a 3D replay animation. Note that we can interactively browse through the spatial behaviour by selecting the linked elements, i.e., nodes or edges, on the process model. Similarly, in the 3D replay animation the process model elements are highlighted.

In an embodiment, spatial conformance was performed. The Spatial Conformance technique provides online classification of a running work process according to a previously built Spatial Process Model. Based on the information recorded while performing the work, i.e., recognised activities and trajectory data, a classifier determines which behaviour clusters of the Spatial Process Model the current work process belongs to. This can be used to provide early detection of non-conforming cases or detect whether different work practices are being used, which may trigger changes in the AR instructions. (FIG. 17)

The input to Spatial Conformance is the sensor data and activity sequence of a running work process instance as well as a previously discovered Spatial Process Model for the same process. The output of the method is the classification of the running process instance into a behaviour cluster of the Spatial Process Model. The first two steps of the Spatial Conformance method are the same as described in the present disclosure.

In an embodiment, classification was performed. The task of the classification module is to determine which behavioural clusters of the Spatial Process Model the current work process is most similar. The most similar cluster is determined at the level of activity instances, i.e., a worker may exhibit non-conforming behaviour for ‘Step A’ but conforming behaviour for ‘Step B’. Here the labels ‘conforming’ and ‘non-conforming’ are used. Often, clusters with the most cases can be regarded as the conformant behaviour. However, smaller clusters may also correspond to different—but conformant—work practices.

The classification module takes as input a prefix of length p of a segmented trajectory ST, which is based on a running process instance:

$$ST = < ( {t}_{1} , ( {tr}_{1 , 1} , {tr}_{1 , 2} , … , {tr}_{1 , n} ) , ( {a}_{1 , 1} , {a}_{1 , 2} , … , {a}_{1 , m} ) ) , … , ( {t}_{p} , ( {tr}_{p , 1} , {tr}_{p , 2} , … , {tr}_{p , n} ) , ( {a}_{p , 1} , {a}_{p , 2} , … , {a}_{p , m} ) ) >$$

Then, the most similar cluster is determined based on a query using the same similarity measure as was used to determine the cluster in the Spatial Discovery method.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order. Flow diagrams of particular embodiments of the presently disclosed methods are depicted in figures. The flow diagrams illustrate the functional information one of ordinary skill in the art requires to perform said methods required in accordance with the present disclosure.

The disclosure should not be seen in any way restricted to the embodiments described and a person with ordinary skill in the art will foresee many possibilities to modifications thereof. The embodiments described above are combinable.

1. A computer-implemented method for building a spatial process map comprised of an operator's physical operations in an industrial work environment, from acquired trajectories comprising position and orientation data provided by a wearable device worn by the user over a period of time,
each trajectory corresponding to one of said operations,
each trajectory comprising a plurality of macro-activities,
each macro-activity comprising micro-activities which are temporally sequenced and nonoverlapping,
said micro-activities comprising one or more labelled micro-activities, and a plurality of unlabelled micro-activities,
each labelled micro-activity being an activity temporally between unlabelled micro-activities;
each labelled micro-activity comprising a spatial-temporal sub-trajectory and an associated activity label, and each unlabelled micro-activity comprising a spatial-temporal sub-trajectory, wherein the trajectory of each labelled micro-activity is a trajectory spatially between unlabelled micro-activity trajectories;
the method being carried out in an electronic data processor configured to comprise the steps of:
receiving acquired operation trajectories which have been previously segmented into macro-activities comprising micro-activities labelled by computer-implemented detecting of previously-known micro-activity patterns in each previously segmented macro-activity;
labelling each detected micro-activity of each segmented macro-activity;
labelling the unlabelled micro-activities with a label that denotes the micro-activity was originally unlabelled;
clustering, for each macro-activity, the labelled and unlabelled micro-activities based on a respective spatial-temporal sub-trajectory of each micro-activity and the associated activity label; and
outputting the clustered micro-activities for each macro-activity.

2. The method according to claim 1, wherein acquiring said acquired operation trajectories comprising position and orientation data is by acquiring 3D position and 3D orientation data provided by an augmented-reality or virtual-reality wearable device as it is being worn by the operator.

3. The method according to claim 2, wherein the acquiring of 3D position and 3D orientation data is provided by further wearable device or devices.

4. The method according to claim 1, wherein the trajectories are head trajectories of the operator and wherein the wearable device is a head-wearable device.

5. The method according to claim 1, wherein the trajectories are head and hand trajectories of the operator and wherein the wearable device is a head-wearable device comprising a 3D tracking camera.

6. The method according to claim 1, wherein the trajectories are hand trajectories of the operator and the wearable device is a hand- or wrist-wearable device comprising a location and orientation sensor.

7. The method according to claim 1, wherein the trajectories are head and gaze trajectories of the operator and wherein the wearable device is a head-wearable device comprising a 3D tracking camera comprising eye-tracking capabilities.

8. The method according to claim 1, further comprising the subsequent steps of:
for each micro-activity within each macro-activity for which micro-activities have been clustered, identifying a most representative micro-activity trajectory;
concatenating the identified most representative micro-activity trajectories of each macro-activity for which micro-activities have been clustered; and
outputting the concatenated micro-activity trajectories for each macro-activity.

9. The method according to claim 1, further comprising the subsequent steps of:
for each macro-activity for which micro-activities have been clustered, identifying a most representative macro-activity trajectory; and
outputting the concatenated micro-activity trajectories for each macro-activity.

10. The method according to claim 1, further comprising a preparation step of segmenting the acquired position and orientation data into a plurality of trajectories, each trajectory corresponding to one of said operations.

11. The method according to claim 1, further comprising a preparation step of detecting previously-known micro-activity patterns in each segmented macro-activity and labelling each detected micro-activity pattern of each segmented macro-activity.

12. The method according to claim 1, further comprising, for each macro-activity, obtaining a sequence graph of the corresponding micro-activities, using the outputted clustered micro-activities for each macro-activity.

13. The method according to claim 1, further comprising, for each macro-activity, obtaining a dispersion measure of the corresponding micro-activities, using the outputted clustered micro-activities for each macro-activity.

14. The method according to claim 1, further comprising calculating a conformance measure using the outputted clustered micro-activities for each macro-activity.

15. A device for building a spatial process map comprised of an operator's physical operations in an industrial work environment, from acquired trajectories comprising position and orientation data provided by a wearable device worn by the user over a period of time;
each trajectory corresponding to one of said operations;
each trajectory comprising a plurality of macro-activities;
each macro-activity comprising micro-activities which are temporally sequenced and nonoverlapping,
said micro-activities comprising one or more labelled micro-activities, and a plurality of unlabelled micro-activities,
each labelled micro-activity being an activity temporally between unlabelled micro-activities;
each labelled micro-activity comprising a spatial-temporal sub-trajectory and an associated activity label, and each unlabelled micro-activity comprising a spatial-temporal sub-trajectory, wherein the trajectory of each labelled micro-activity is a trajectory spatially between unlabelled micro-activity trajectories;
the device comprising an electronic data processor configured for carrying out the steps of:
receiving acquired operation trajectories which have been previously segmented into macro-activities comprising micro-activities labelled by computer-implemented detecting of previously-known micro-activity patterns in each previously segmented macro-activity and labelling each detected micro-activity of each segmented macro-activity;
labelling the unlabelled micro-activities with a label that denotes the micro-activity was originally unlabelled;
clustering, for each macro-activity, the labelled and unlabelled micro-activities based on a respective spatial-temporal sub-trajectory of each micro-activity and the associated activity label; and
outputting the clustered micro-activities for each macro-activity.

16. The method according to claim 7, wherein the trajectory being selected is by using a median trajectory selection.

17. The method according to claim 8, wherein the trajectory being selected is by using a median trajectory selection.
